(19) United States
(12) Patent Application Publication
(10) Pub. No.: US 2016/0281641 A1
(43) Pub. Date: Sep. 29, 2016

(54) A PROPULSION ASSEMBLY AND A METHOD OF FEEDING PROPELLANTS

(71) Applicant: SNECMA, Paris (FR)

(72) Inventors: François DANGUY, Tourny (FR); David HAYOUN, Paris (FR); Jean Michel SANNINO, Saint-Marcel (FR)

(73) Assignee: SNECMA, Paris (FR)

(21) Appl. No.: 15/034,215

(22) PCT Filed: Nov. 5, 2014
(86) PCT No.: PCT/FR2014/052820

§ 371 Date: May 4, 2016

(30) Foreign Application Priority Data
Nov. 6, 2013 (FR) 1360849

(51) Int. Cl. F02K 9/42; F02K 9/48

(52) U.S. Cl. CPC F02K 9/425; F02K 9/48

(57) ABSTRACT

The invention relates to the field of rocket engines, and more particularly to a propulsion assembly (10) comprising a first tank (11) for a first liquid propellant, a second tank (12) for a second liquid propellant, a pressurizer device (60) configured to maintain a substantially higher pressure in the second tank (12) than in the first tank (11), and a single-shaft turbopump (30) comprising a turbine (33), a first pump (31), and a second pump (32). The turbine (33) is actuated by expansion of the first propellant after it has passed through a regenerative heat exchanger (44), and in turn it acts via the single rotary shaft (34) of the turbopump (30) to drive said first and second pumps (31, 32) respectively pumping said first and second propellants in order to feed a propulsion chamber (40).

### BACKGROUND OF THE INVENTION

The present invention relates to the field of liquid propellant rocket engines. The term “liquid propellant rocket engine” is used in the present context to mean a propulsion assembly comprising a first tank suitable for containing a first liquid propellant, a second tank suitable for containing a second liquid propellant, and a propulsion chamber suitable for generating thrust by combustion and expansion of a mixture of said propellants.

In order to maximize the thrust produced by such a propulsion assembly, it is appropriate to increase the pressure that exists inside the propulsion chamber as much as possible. In order to be able to continue to feed the propulsion chamber in spite of such high pressures, the propellants need to be injected at pressures that are even higher. Various techniques are known in the state of the art for this purpose.

First means that have been proposed comprise pressurizing the tanks containing the propellants. Nevertheless, this approach puts a severe limit on the maximum pressure that can be reached in the propulsion chamber, and thus on the specific impulse of the reaction engine. Consequently, in order to obtain higher specific impulses, it has become common practice to use feed pumps. Various means have been proposed to actuate such pumps, and the most common is for them to be driven by at least one turbine. In such a turbopump, the turbine may itself be actuated in several different ways. For example, the turbine may be actuated by combustion gases produced by a gas generator. Nevertheless, in so-called “expander cycle” rocket engines, the turbine is actuated by one of the propellants after it has passed through a heat exchanger in which it is heated by the heat produced in the propulsion chamber. Thus, this transfer of heat can contribute simultaneously to cooling the walls of the propulsion chamber and to actuating at least one feed pump.

Although expander cycle rocket engines can be technically simpler than engines including a gas generator, they nevertheless remain relatively complex, thereby increasing both cost and also risk of failure in comparison with rocket engines in which the propulsion chamber is fed with propellants merely by pressurizing the tanks. In particular, when the propellants are of different densities, this can prevent the use of pumps rotating at the same speed for the various propellants. Consequently, it becomes necessary to use separate turbopumps for the various propellants, or at least to use turbopumps having shafts that can rotate at different speeds.

### OBJECT AND SUMMARY OF THE INVENTION

The present invention seeks to remedy those drawbacks. In particular, the present disclosure seeks to propose a propulsion assembly that makes it possible to reach a high specific impulse with propellant feed systems that are comparatively simple and lightweight. In at least one embodiment, the propulsion assembly comprises a first tank, a second tank, and a propulsion chamber, the first tank being suitable for containing a first liquid propellant, the second tank being suitable for containing a second propellant, and the propulsion chamber being suitable for generating thrust by combustion and expansion of a mixture of said propellants. In addition, the propulsion assembly also has first and second feed circuits respectively connecting the first and second tanks to the propulsion chamber in order to feed the latter with the propellant. The first propellant circuit includes a regenerative heat exchanger arranged to heat said first propellant with heat coming from the propulsion chamber, and the propulsion assembly also includes a turbopump comprising a turbine, a first pump, and a second pump. Said first pump has the first feed circuit passing therethrough upstream from said regenerative heat exchanger, said second pump has the second feed circuit passing therethrough, and said turbine has the first feed circuit passing therethrough downstream from said regenerative heat exchanger. This propulsion assembly thus comprises an expander cycle rocket engine in which the turbopump is actuated by expanding the first propellant after it has been heated by passing through the heat exchanger.

At least in this embodiment, the above-mentioned object is achieved in that the second tank is suitable for containing a second propellant, the propulsion assembly also including a pressurizer device configured to maintain a pressure in the second tank that is considerably higher than the pressure in the first tank, and in that the turbopump is a single-shaft turbopump, in which the first and second pumps are both connected to the turbine by a single rotary shaft. In particular, the pressurizer device may be configured to maintain a pressure in the second tank of at least 2 megapascals (MPa), and in particular of at least 3 MPa. The pressure of the second tank makes it possible to use a single-shaft turbopump in which the first and second pumps rotate at the same speed, even through the second propellant presents density that is substantially greater than the density of the first propellant, since the second pump is force-fed by the internal pressure of the second tank, thereby reducing the power needing to be delivered via the second pump.

The turbine may have the first feed circuit pass therethrough between said regenerative heat exchanger and said propulsion chamber. Thus, in operation, the first propellant is injected into the propulsion chamber after partial expansion in the turbine.

Nevertheless, said turbine may alternatively have a branch connection of the first feed circuit pass therethrough downstream from at least a portion of said regenerative heat exchanger, said branch connection not leading to the propulsion chamber. Thus, in this other variant, only a portion of the flow of the first propellant is used for actuating the turbine. Nevertheless, since the branch connection does not lead into the propulsion chamber, the expansion of this branch flow through the turbine can be more complete, thereby enabling substantially the same power to be obtained as if all of the flow of the first propellant were used.

In particular in order to facilitate axial feed for both pumps, which is beneficial for their efficiency, the turbine may be placed between the first pump and the second pump. In particular, the first pump and the second pump may be cantilevered out relative to bearings supporting the rotary shaft.

In particular, in order to limit the space occupied by the turbine and make it easier to integrate with the two pumps, said turbine may in particular be an axial turbine. Furthermore, in order to maximize the efficiency of the pumps, at least one of first and second pumps may be a centrifugal pump.

The use of advanced materials for the structure of the second tank makes it possible to minimize the additional weight required for withstanding its internal pressure. In particular, said second tank may be made at least in part out of composite material, and more particularly, it may comprise a wound composite structure. In the present context, the term “composite material” is used to mean a material having two distinct components that are not miscible. More particularly, reference may be made to an organic matrix composite material that is reinforced by fibers, having fibers such as glass fibers, carbon fibers, and/or organic fibers that are embedded in a matrix that is organic, generally polymeric. Typically, the wound composite structure is a hollow structure created by winding such fibers impregnated with a thermosetting resin or a thermoplastic in the liquid state around a solid core which is itself hollow or suitable for being destroyed or extracted from the wound composite structure after the impregnated fibers have been wound and the matrix has been solidified.

In order to obtain high energy density for the propellants, at least one of said liquid propellants may be a cryogenic propellant. In the present context, the term “cryogenic propellant” is used to mean a propellant that is kept liquid at a temperature below 120 kelvins (K). In particular, said first liquid propellant may be liquid hydrogen and said liquid second propellant may be liquid oxygen.

The present disclosure also relates to a space vehicle including the above-mentioned propulsion assembly. In this context, the term “space vehicle” should be understood broadly, also covering, by way of example, space launchers and their individual stages.

Finally, the present disclosure also relates to a feed method for feeding liquid propellants to a propulsion chamber of a propulsion assembly, wherein a flow of a first liquid propellant is extracted from a first tank via a first feed circuit, in which the flow is initially pumped by a first pump of a single-shaft turbopump, heated in a regenerative heat exchanger with heat coming from the propulsion chamber, and is then expanded in a turbine of said single-shaft turbopump in order to drive said first pump and a second pump of the single-shaft turbopump via a single rotary shaft connecting the turbine to both pumps of the single-shaft turbopump, and wherein a flow of a second liquid propellant is extracted from a second tank in which the second liquid propellant is maintained by a pressurizer device at a pressure that is substantially higher than the pressure of the first liquid propellant in the first tank, which flow passes via a second feed circuit in which it is pumped by said second pump prior to being injected into the propulsion chamber.

In this method, in two different alternatives, either all of said flow of the first liquid propellant is expanded in said turbine prior to being injected into the propulsion chamber, or else a first portion of said flow of the first liquid propellant is taken off via a branch connection of the first feed circuit downstream from at least a portion of said regenerative heat exchanger in order to be expanded in said turbine, while a second portion of said flow of the first liquid propellant is injected into the propulsion chamber.

### BRIEF DESCRIPTION OF THE DRAWINGS

The invention can be well understood and its advantages appear better on reading the following detailed description of two embodiments given as non-limiting examples. The description refers to the accompanying drawings, in which:

FIG. 1 is a diagram of a multistage space launcher;

FIG. 2 is a diagram showing a propulsion assembly in a first embodiment of the invention; and

FIG. 3 is a diagram showing a propulsion assembly in a second embodiment of the invention.

### DETAILED DESCRIPTION OF THE INVENTION

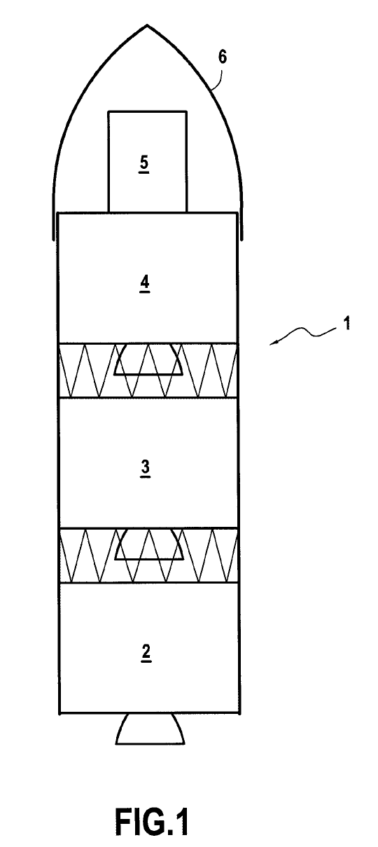

A multistage space launcher 1 is shown diagrammatically in FIG. 1. The launcher 1 shown comprises three successive stages 2, 3, and 4, and a payload 5, e.g. such as a satellite, under a nose cone 6 that is releasably fastened on the last of the three stages. Each of the three stages 2, 3, and 4 has a rocket engine type propulsion assembly, thus enabling the payload 5 to be launched and put into orbit. For this purpose, the propulsion assemblies of the three stages 2, 3, and 4 are fired in succession, with each spent stage being separated prior to firing the propulsion assembly of the following stage.

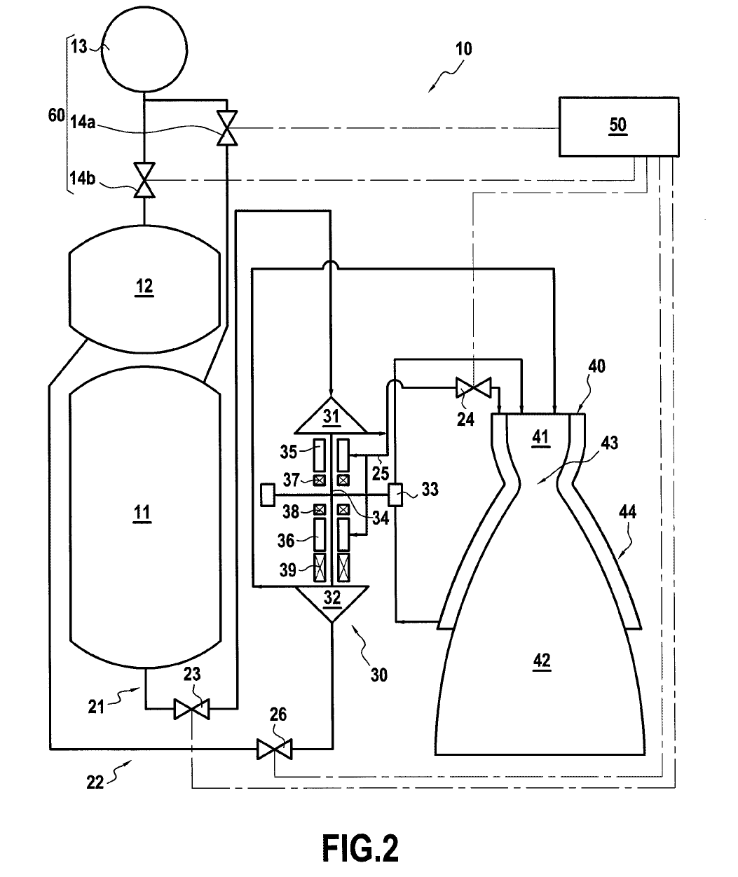

FIG. 2 shows a propulsion assembly 10 in a first embodiment. This propulsion assembly 10 may form part of any of the stages of such a space launcher, or even part of a space vehicle that is launched as payload by means of such a space launcher. The propulsion assembly 10 shown is a rocket engine having an expander cycle, i.e. a rocket engine having liquid propellants and turbopump feed, in which the turbopump is actuated by the expansion of one of the propellants after it has been heated and vaporized in a regenerative heat exchanger that is heated by the propulsion chamber.

The propulsion assembly 10 shown comprises a first tank 11, a second tank 12, a third tank 13, a first feed circuit 21, a second feed circuit 22, a turbopump 30, and a propulsion chamber 40. The first tank 11 is suitable for containing a first cryogenic liquid propellant, e.g. such as liquid hydrogen (LH₂) at an internal pressure p₁₁ that may be close to standard atmospheric pressure (about 0.1 MPa). The second tank 12 is suitable for containing a second cryogenic liquid propellant, that is of substantially greater density than the first propellant, e.g. such as liquid oxygen (LOX) at an internal pressure p₁₂ that is substantially higher than the internal pressure p₁₁ of the first tank 11. For example, this pressure p₁₂ may be at least 2 MPa, or indeed at least 3 MPa. In order to maintain these pressures p₁₁ and p₁₂ respectively in the first tank 11 and in the second tank 12, the propulsion assembly 10 also has a pressurizer device 60 comprising a third tank 13 connected to the first tank 11 via a valve 14a and to the second tank 12 via another valve 14b. The third tank 13 is suitable for containing a pressurizer fluid, e.g. such as gaseous helium. Consequently, the third tank 13 is suitable for withstanding an internal pressure p₁₃ that is even higher than the pressure p₁₂ of the second tank 12.

In order to enable the second tank 12 to be pressurized at the pressure p₁₂ without suffering an unacceptable weight penalty, the second tank may be made of composite material. More specifically, it may have a wound composite structure. The same means may also be used for the third tank 13.

Although, in the embodiments shown, the pressurizer device 60 has a single tank 13, with same pressurizer fluid thus being used both for the first tank 11 and for the second tank 12, it is also possible to envisage that the pressurizer device 60 has two separate tanks, one for each of the propellant tanks 11 and 12. Thus, a different pressurizer fluid could be used in each of the two propellant tanks 11 and 12. Furthermore, as an alternative or in addition to at least one pressurizer fluid tank, the pressurizer device 60 could also include, for each of the propellant tanks 11 and 12, autogenous pressurizer means (not shown) using the same propellant as is contained in the tanks 11, 12 after it has been heated and after it has passed to the gaseous state so as to maintain the pressure p₁₁, p₁₂. Such autogenous pressurization, at least during periods in which the propulsion assembly 10 is in operation, make it possible to reduce requirements for pressurizer fluid, and thus to reduce the size of the pressurizer fluid tank(s).

The turbopump 30 is a single-shaft turbopump with a first pump 31, a second pump 32, and a turbine 33 mechanically interconnected by a single common rotary shaft 34. The turbine 33, which is an axial turbine, is placed between the two pumps 31 and 32. The pump 31 is a centrifugal pump, while the pump 32 may be an axial pump. The speed of rotation is optimized for the pump 31 and for the turbine 33, which is compatible with an axial pump 32 and enables the compact turbopump 30 to be very compact because of its high speed of rotation. The pumps 31 and 32 are cantilevered out relative to bearings 35 and 36 that support the rotary shaft 34. With a turbine 33 of diameter greater than the diameter of the pumps 31 and 32, and/or with axial admission to the pumps 31 and 32 that are outwardly oriented relative to the turbine 33, it is possible to minimize the space occupied by the turbopump 30, thereby making it easier to integrate in the propulsion assembly 10. Sealing gaskets 37, 38 around the rotary shaft 34 serve to separate the turbine 33 from the two bearings 35, 36. Another barrier 39 that provides a very high level of sealing is interposed between the bearing and the second pump 32 so as to avoid contact between the first and second propellants within the turbopump 30.

The propulsion chamber 40 comprises a combustion chamber 41 for combustion of a mixture of the two propellants, and a converging/diverging nozzle 42 with a throat 43 for expanding and supersonically accelerating the resulting combustion gas in order to generate thrust in the opposite direction.

The first feed circuit 21 connects the first tank 11 to the propulsion chamber 40 by passing via the first pump 31, a regenerative heat exchanger 34, and the turbine 33. The second feed circuit 21 also has at least two vales 23, 24 that are situated respectively between the first tank 11 and the first pump 31, and between the first pump 31 and the heat exchanger 44. The heat exchanger 44 that serves to transmit heat from the propulsion chamber 40 to the propellant flowing in the first circuit 21 may be incorporated in an outer wall of the propulsion chamber 40, in particular around the combustion chamber 41 and its throat 43. In this way, the heat exchanger 44 serves not only to heat the propellant, but also to cool the outer wall, thus making it possible to reach particularly high temperatures within the propulsion chamber 40 without running the risk of damaging its outside wall. A small branch connection 25 on the circuit 21 directly downstream from the first pump 21 is connected to the bearings 35 and 36 in order to lubricate them with the first propellant.

The second feed circuit 22 connects the second tank 12 to the propulsion chamber 40 by passing via the second pump 32. This second feed circuit also has at least one valve 26 situated between the second tank 12 and the second pump 32.

In order to control the operation of the propulsion assembly 10, the valves 14a, 14b, 23, 24, and 26 are connected to a control unit 50 for controlling them. The propulsion assembly may also include sensors (not shown) that are likewise connected to the control unit 50 in order to return information about the operation of the propulsion assembly 10.

In operation, after the feed circuits 21, 22 and the turbopump 30 have been cooled down, and after the propellants have initially reached the propulsion chamber 40 and been ignited, the first propellant flowing from the first tank 11 towards the propulsion chamber 40 is heated on passing through the heat exchanger 44 by the heat produced by the combustion of the propellants in the propulsion chamber 40. The propellant as heated in this way may pass from the liquid state to the gaseous state prior to reaching the turbine 33 in which its partial expansion enables it to drive the two pumps 31 and 32 by means of the rotary shaft 34. This expansion is partial only so that the remaining pressure of the first propellant downstream from the turbine 33 remains sufficient to enable the first propellant to be injected into the propulsion chamber 40. The first pump 31 thus maintains feed to the propulsion chamber 40 of the first propellant, which continues to be extracted from the first tank 11 upstream from the pump 31. The second propellant, at the internal pressure p₁₂ of the second tank 12, as maintained by the pressurizer fluid contained in the first tank, serves to force-feed the second pump 32, thereby correspondingly reducing the pumping power required of said second pump 32 in order to continue feeding the propulsion chamber 40 with the second propellant. Thus, in spite of the higher density of the second propellant compared with the first propellant, both pumps 31 and 32 can rotate at the same speed, and can therefore be driven by a common turbine 33 with a common rotary shaft 34.

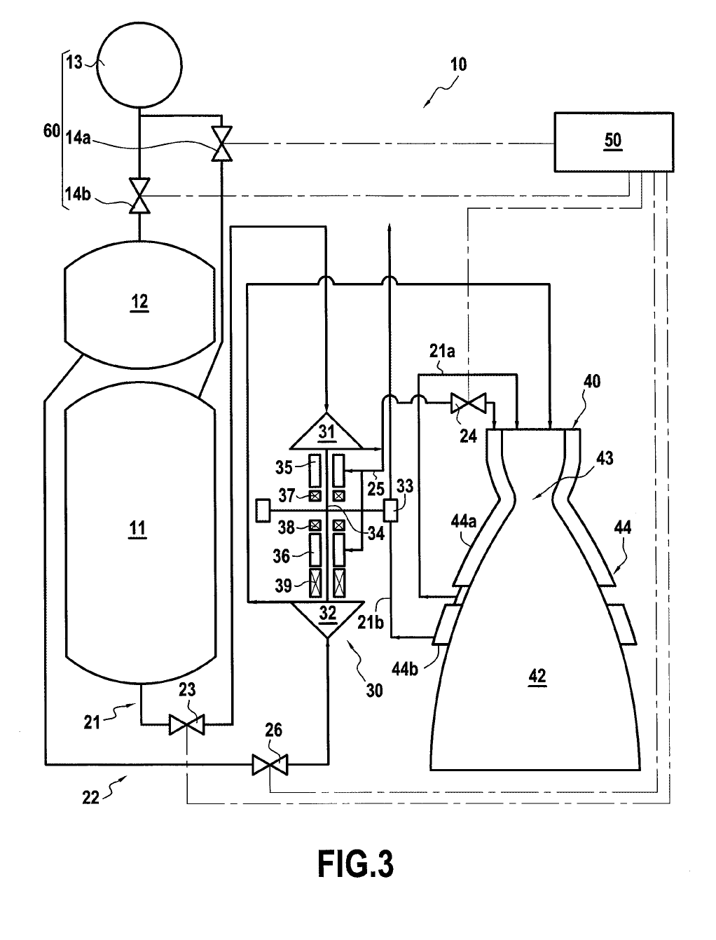

Although in the above-mentioned first embodiment the main flow of the first propellant is subjected to partial expansion in the turbine prior to being injected into the propulsion chamber, it is also possible to actuate the turbine with a branch flow, in particular if expansion within the turbine is more complete, meaning that this branch flow can then no longer be injected into the propulsion chamber. Thus, in a second embodiment, as shown in FIG. 3, the regenerative heat exchanger 44 has two segments 44a and 44b, and the first feed circuit 21 includes a branch connection 21b downstream from the first segment 44a of the heat exchanger 44, passing through the second segment 44b of the heat exchanger 44 and the turbine 33 and not leading to the propulsion chamber 40, unlike a main branch 21a that does indeed lead into the propulsion chamber. The remaining elements of this propulsion assembly 10 are analogous to those of the first embodiment and consequently they are given the same reference numbers.

In operation, in this second embodiment, a main flow of the first propellant is injected into the propulsion chamber 40 via the main branch 21a of the first feed circuit 21 after passing through the first segment 44a of the heat exchanger 44, in which it is heated. Nevertheless, a secondary flow of the first propellant is taken off via the branch connection 21b and passes through the second segment 44b of the heat exchanger 44 where it is superheated, prior to passing through the turbine 33 that drives the pumps 31 and 32 as a result of this secondary flow expanding within the turbine 33. After it has expanded, the secondary flow is no longer injected into the propulsion chamber 40 since its pressure is not high enough for that, but, by way of example, it may be expelled to the outside via a secondary nozzle (not shown).

In comparison, the propulsion assembly of the first embodiment can nevertheless obtain a specific impulse that is higher (possibly at least 10 seconds (s) higher if the propellants are liquid hydrogen and oxygen) than the specific impulse of the second embodiment. In addition, the combustion pressure may be lower in the first embodiment, e.g. going from 7.5 MPa to 5.5 MPa, thereby reducing the extra pressure that needs to be delivered by the second pump. Even if the extra pressure that needs to be delivered by the first pump in the first embodiment is comparatively higher, since it must subsequently allow the first propellant to expand in part prior to being injected, it potentially remains compatible with the performance of a single stage centrifugal pump, because of the lower combustion pressure.

In any event, the two embodiments shown make it possible to reduce the pressure in the second tank compared with a comparable propulsion assembly in which the turbopump is used exclusively for pumping the first propellant and the second propellant is injected into the propulsion chamber solely as a result of the second tank being pressurized. Furthermore, compared with a comparable propulsion assembly in which the first and second propellant tanks are maintained at similar pressures and propellant feed is provided by two separate turbopumps, these embodiments present the advantage of enabling the moving elements to be simpler since in both embodiments shown a single single-shaft turbopump serves to pump both propellants.

Although the present invention is described with reference to specific embodiments, it is clear that various modifications and changes may be made on these embodiments without going beyond the general ambit of the invention as defined by the claims. In addition, the individual characteristics of the various embodiments mentioned may be combined in additional embodiments. Consequently, the description and the drawings should be considered in a sense that is illustrative rather than restrictive.

1. A propulsion assembly comprising at least:
a first tank suitable for containing a first liquid propellant;
a second tank suitable for containing a second liquid propellant;
a pressurizer device configured to maintain a substantially higher pressure in the second tank than in the first tank;
a propulsion chamber suitable for generating thrust by combustion and expansion of a mixture of said propellants;
a first feed circuit connecting the first tank to the propulsion chamber in order to feed the propulsion chamber with the first propellant, and including a regenerative heat exchanger arranged to heat said first propellant with heat coming from the propulsion chamber;
a second feed circuit connecting the second tank to the propulsion chamber in order to feed the propulsion chamber with the second propellant; and
a single-shaft turbopump comprising a turbine, a first pump, and a second pump, said first pump and said second pump being mechanically connected to said turbine for actuation by a single rotary shaft, said first pump having the first feed circuit pass therethrough upstream from said regenerative heat exchanger, said second pump having the second feed circuit pass therethrough, and said turbine having the first feed circuit pass therethrough downstream from said regenerative heat exchanger.

2. The propulsion assembly according to claim 1, wherein said turbine has the first feed circuit pass therethrough between said regenerative heat exchanger and said propulsion chamber.

3. The propulsion assembly according to claim 1, wherein said turbine has a branch connection of the first feed circuit pass therethrough downstream from at least a portion of said regenerative heat exchanger, said branch connection not leading to the propulsion chamber.

4. The propulsion assembly according to claim 1, wherein the first tank is suitable for maintaining an internal pressure of at least 2 MPa, and in particular of at least 3 MPa.

5. The propulsion assembly according to claim 1, wherein the turbine is placed between the first pump and the second pump .

6. The propulsion assembly according to claim 5, wherein the first pump and the second pump are cantilevered out relative to bearings supporting the rotary shaft.

7. The propulsion assembly according to claim 1, wherein said turbine is an axial turbine.

8. The propulsion assembly according to claim 1, wherein the first pump is a centrifugal pump and the second pump is an axial pump.

9. The propulsion assembly according to claim 1, wherein said second tank is made at least in part out of composite material.

10. The propulsion assembly according to claim 9, wherein said second tank comprises a wound composite structure.

11. The propulsion assembly according to claim 1, wherein at least one of said liquid propellants is a cryogenic propellant.

12. The propulsion assembly according to claim 11, wherein said first liquid propellant is liquid hydrogen.

13. The propulsion assembly according to claim 11, wherein said second liquid propellant is liquid oxygen.

14. A space vehicle including the propulsion assembly according to claim 1.

15. A feed method for feeding liquid propellants to a propulsion chamber of a propulsion assembly, the method comprising:
extracting a flow of a first liquid propellant from a first tank via a first feed circuit, wherein the flow is initially pumped by a first pump of a single-shaft turbopump, heated in a regenerative heat exchanger with heat coming from the propulsion chamber, and is then expanded in a turbine of said single-shaft turbopump in order to drive said first pump and a second pump of the single-shaft turbopump via a single rotary shaft connecting the turbine to both the first pump and the second pump of the single-shaft turbopump; and
extracting a flow of a second liquid propellant from a second tank, wherein the second liquid propellant is maintained by a pressurizer device at a pressure that is substantially higher than the pressure of the first liquid propellant in the first tank, which flow passes via a second feed circuit in which it is pumped by said second pump prior to being injected into the propulsion chamber.

16. The feed method according to claim 15, wherein the first liquid propellant is injected into the propulsion chamber after partial expansion in the turbine.

17. A feed method according to claim 15, wherein a first portion of said flow of the first liquid propellant is taken off via a branch connection of the first feed circuit downstream from at least a portion of said regenerative heat exchanger in order to be expanded in said turbine, while a second portion of said flow of the first liquid propellant is injected into the propulsion chamber.
